(19) United States
(12) Patent Application Publication
(10) Pub. No.: US 2008/0036411 A1
(43) Pub. Date: Feb. 14, 2008

(54) Air cleaner and air cleaner state backup

(75) Inventors: Bruce Kiern, Gulfport, MS (US); Christopher M. Paterson, Biloxi, MS (US)

Correspondence Address: THE OLLILA LAW GROUP LLC, 2060 BROADWAY, SUITE 300, BOULDER, CO, 80302, US

(73) Assignee: Oreck Holdings, LLC

(21) Appl. No.: 11/501,299

(22) Filed: Aug. 9, 2006

(51) Int. Cl. H02P 1/00; G05B 5/00; F24F 7/00

(52) U.S. Cl. 318/558; 318/449; 236/49.1

(57) ABSTRACT

An air cleaner is provided according to an embodiment of the invention. The air cleaner includes a volatile memory including an air cleaner state memory element and a non-volatile memory including an air cleaner state backup memory element. The air cleaner is configured to store an air cleaner state to the air cleaner state memory element of the volatile memory and store the air cleaner state to the air cleaner state backup memory element of the non-volatile memory.

### TECHNICAL FIELD

The present invention relates to an air cleaner and an air cleaner state backup.

### BACKGROUND OF THE INVENTION

Air cleaners are widely used in home and office settings for cleaning the air. An air cleaner can filter the air in order to remove airborne contaminants. An air cleaner can therefore include any type of mechanical filter element comprising a mesh, a weave, a foam, etc. An air cleaner can further include electrical air cleaning components, such as a collector cell that removes dirt and debris from the airflow of the air cleaner. A collector cell can include an ionizer and/or an electrostatic precipitator.

An air cleaner also includes some manner of air moving device that creates an airflow through the filter element and/or electrical air cleaning components. The air moving device typically includes several speed settings that allow the user to control the level of operation of the air cleaner. The user can manipulate controls provided through a control panel in order to select from available operating features or settings.

In the prior art, an air cleaner typically includes controls for setting the operational state, among other things. However, a prior art air cleaner does not store and retain an operational state over power cycles or over losses of electrical power due to operational faults.

### SUMMARY OF THE INVENTION

An air cleaner is provided according to an embodiment of the invention. The air cleaner comprises a volatile memory including an air cleaner state memory element and a non-volatile memory including an air cleaner state backup memory element. The air cleaner is configured to store an air cleaner state to the air cleaner state memory element of the volatile memory and store the air cleaner state to the air cleaner state backup memory element of the non-volatile memory.

An air cleaner is provided according to an embodiment of the invention. The air cleaner comprises a volatile memory including an air cleaner state memory element, a non-volatile memory including an air cleaner state backup memory element, and a processing system coupled to the volatile memory and to the non-volatile memory. The processing system is configured to store an air cleaner state to the air cleaner state memory element of the volatile memory and store the air cleaner state to the air cleaner state backup memory element of the non-volatile memory.

An air cleaner state backup method is provided according to an embodiment of the invention. The method comprises storing an air cleaner state to an air cleaner state memory element of a volatile memory and storing the air cleaner state to an air cleaner state backup memory element of a non-volatile memory.

### BRIEF DESCRIPTION OF THE DRAWINGS

The same reference number represents the same element on all drawings.

FIG. 1 shows an air cleaner according to an embodiment of the invention.

FIG. 2 is a flowchart of an air cleaner state backup method according to an embodiment of the invention.

FIG. 3 is a flowchart of an air cleaner state backup method according to an embodiment of the invention.

FIG. 4 shows detail of a control panel of the air cleaner according to an embodiment of the invention.

FIG. 5 shows the control panel of the air cleaner according to another embodiment of the invention.

### DETAILED DESCRIPTION OF THE INVENTION

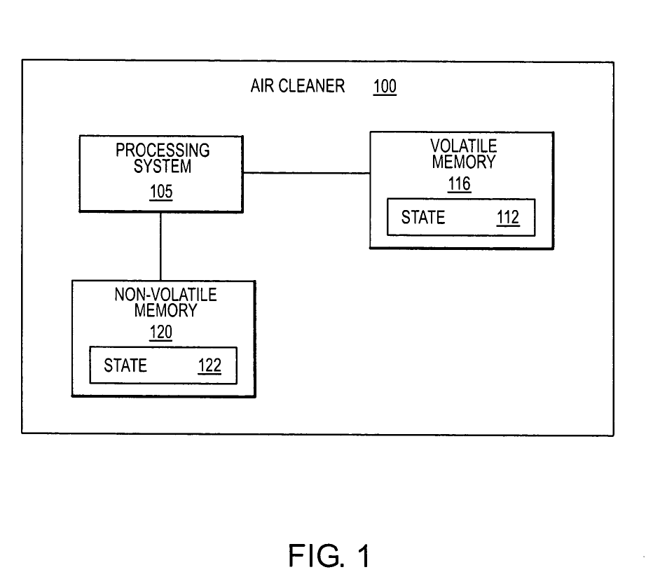

FIGS. 1-5 and the following descriptions depict specific embodiments to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will also appreciate that the features described below can be combined in various ways to form multiple variations of the invention. As a result, the invention is not limited to the specific embodiments described below, but only by the claims and their equivalents.

FIG. 1 shows an air cleaner 100 according to an embodiment of the invention. The air cleaner 100 in the embodiment shown includes a processing system 105, a volatile memory 110, and a non-volatile memory 120. The volatile memory 110 and the-non-volatile memory 120 are coupled to the processing system 105. The processing system 105 can store and retrieve data from the volatile memory 110 and the non-volatile memory 120.

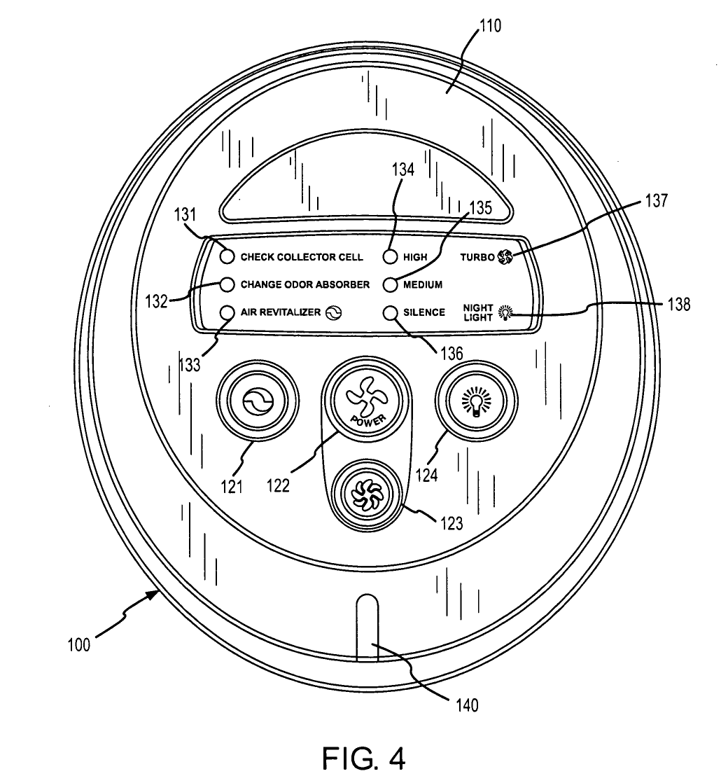

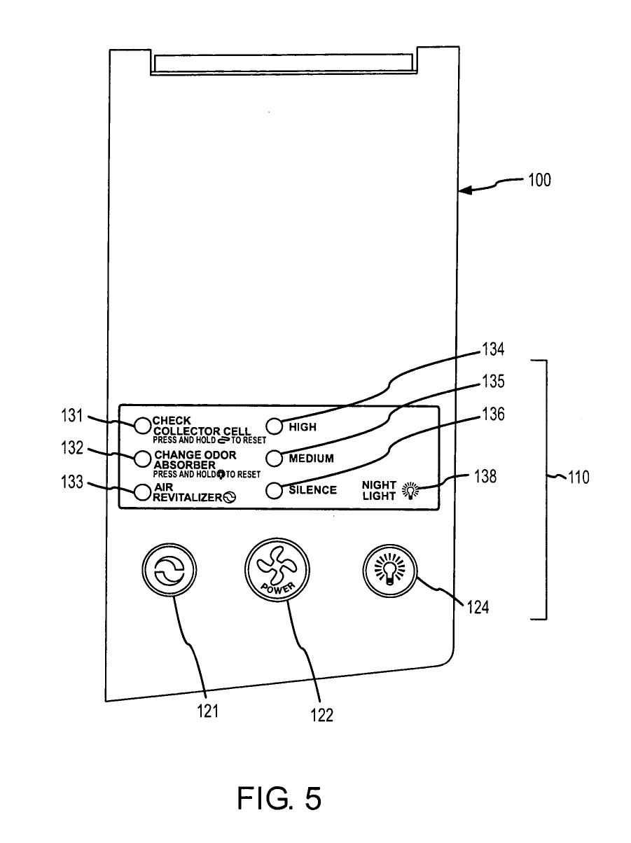

The volatile memory 110 can comprise any suitable memory. The volatile memory 110 advantageously can store and retrieve data at very fast speeds and with very short response times. The volatile memory 110 includes an air cleaner state memory element 112 that stores an air cleaner state. In some embodiments, the air cleaner state comprises an operational state of the air cleaner 100. For example, the air cleaner state can include the state of an air moving device and can include an off state, a low (i.e., silence) air speed state through the air cleaner 100, a medium air speed state, and a high air speed state (see FIGS. 4 and 5). In addition, the air cleaner state can additionally include a very high air speed state, such as a turbo state. Further, in some embodiments the air cleaner state can include a nightlight on/off state. Other air cleaner states are contemplated and are within the scope of the description and claims.

The non-volatile memory 120 can comprise any suitable memory. The non-volatile memory 120 advantageously can store and maintain data even when no electrical power is being provided to the non-volatile memory 120. The non-volatile memory 120 can therefore preserve data over power cycles of the air cleaner 100, at times when the air cleaner 100 does not have power, or after an operational fault of the air cleaner 100. The non-volatile memory 120 includes an air cleaner state backup memory element 122 that stores a backup value of the air cleaner state 112.

In one embodiment, the non-volatile memory 120 can comprise an Erasable Programmable Read-Only Memory (EPROM) or an Electrically Erasable Programmable Read-Only Memory (EEPROM). The non-volatile memory 120 can alternatively comprise flash memory. Other non-volatile memory types are contemplated and are within the scope of the description and claims.

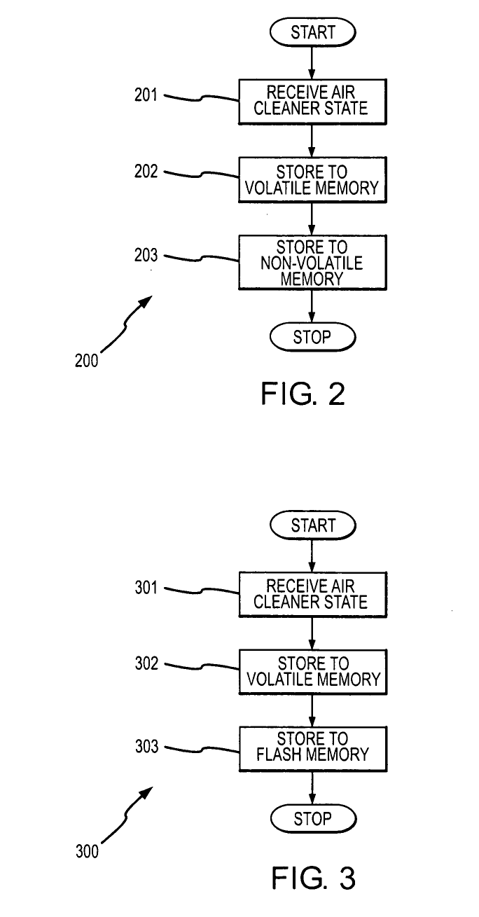

The processing system 105 can comprise any electronic circuitry that stores and retrieves data from a digital memory. The processing system 105 can comprise a processor, specialized chip, circuitry, etc. In addition, the processing system 105 can further control or interact with other components and/or features of the air cleaner 100. Operation of the processing system 105 is discussed below, in conjunction with FIG. 2.

FIG. 2 is a flowchart 200 of an air cleaner state backup method according to an embodiment of the invention. In step 201, an air cleaner state is received. The air cleaner state can be received in the processing system 105, for example. The air cleaner state can be received upon a state change. The state change can occur due to any cause and can occur at any time. For example, a state change can occur upon a user action to a control panel of the air cleaner 100. The user can change a fan speed in order to cause a state change. The user can turn components on and off to cause a state change. Alternatively, the air cleaner state can be received upon an operational change in the air cleaner 100. For example, a predetermined routine or function can be programmed into the air cleaner 100 and can autonomously initiate a state change.

In step 202, the air cleaner state is saved to the air cleaner state memory element 112. The air cleaner state memory element 112 comprises a volatile memory element that retains the air cleaner state for as long as the state memory element 112 is provided with electrical power.

In step 203, the air cleaner state is further saved to the air cleaner state backup memory element 122. The air cleaner state backup memory element 122 comprises a non-volatile memory element that retains the air cleaner state even in the absence of electrical power. Therefore, over power cycles or power losses, the air cleaner state backup memory element 122 can be accessed in order to restore a pre-power cycle or pre-power loss air cleaner state. In addition, in the event of an operational failure, a previous air cleaner state can be recovered and resumed.

FIG. 3 is a flowchart 300 of an air cleaner state backup method according to an embodiment of the invention. In step 3201, a state change is received, as previously discussed.

In step 302, the air cleaner state is saved to the air cleaner state memory element 112, as previously discussed.

In step 303, the air cleaner state is further saved to the air cleaner state backup memory element 122. The air cleaner state backup memory element 122 in this embodiment comprises a flash memory element that retains the air cleaner state even in the absence of electrical power. Flash memory is a non-volatile memory that is electrically programmable and electrically erasable. The erasing and programming can be very quickly performed in a flash memory. Therefore, the air cleaner state backup memory element 122 can be employed in order to store and recover a pre-power cycle or pre-power loss air cleaner state. In addition, in the event of an operational failure, a previous air cleaner state can be recovered and resumed.

FIG. 4 shows detail of a control panel 110 of the air cleaner 100 according to an embodiment of the invention. The control panel 110 can generate operational changes and/or state changes. The control panel 110 includes various controls, including an air revitalizer (i.e., ionizer) button 121, a fan power button 122, a fan turbo button 123, and a nightlight control 124.

Pressing the air revitalizer button 121 turns the air revitalizer on and off. Pressing the fan power button 122 cycles the fan of the air cleaner 100 through the fan power levels. To turn the air cleaner 100 on, the user presses the fan power button 122 once. Power comes on in the low i.e., “silence” setting. Subsequent presses of the fan power button 122 transitions the fan to the medium speed, to the high speed, and then turns the fan off. The electrostatic precipitator cell is turned on when the fan is running at any speed. Pressing the fan turbo button 123 runs the fan at its highest speed, the turbo speed. This speed setting is accompanied by illumination of the turbo fan speed indicator 137. The electrostatic precipitator is on when the fan is at the turbo speed setting. The turbo speed setting can be turned off by a subsequent press of the fan turbo button 123 or by cycling off the power of the air cleaner 100, for example.

The control panel further includes various visual indicators, including a check collector cell indicator 131, a change odor absorber indicator 132, an air revitalizer indicator 133, a high fan speed indicator 134, a medium fan speed indicator 135, a silence fan speed indicator 136, a turbo fan speed indicator 137, and a nightlight indicator 138.

The check collector cell indicator 131 is generally illuminated when a collector cell (i.e., electrostatic precipitator) of the air cleaner 100 is dirty and requires cleaning. The collector cell may require cleaning after a predetermined number of hours of operation, for example. The check collector cell indicator 131 can be illuminated when a corresponding collector cell timer indicates that a predetermined time period has elapsed.

The change odor absorber indicator 132 is generally illuminated when an odor absorber requires replacement. The odor absorber may require replacement when an odor absorber material has been consumed or effectively clogged up. The change odor absorber indicator 132 can be illuminated when a corresponding odor absorber timer indicates that a predetermined time period has elapsed.

The air revitalizer indicator 133 is generally illuminated when the air revitalizer (i.e., air ionizer) is operating and ionizing airflow through the air cleaner 100. The air revitalizer indicator 133 is correspondingly turned on and off when the air revitalizer is turned on and off.

The high fan speed indicator 134 is generally illuminated during a high fan output setting. The high indicator 134 is correspondingly turned on and off when the high fan output setting is turned on and off.

The medium fan speed indicator 135 is generally illuminated during a medium fan output setting. The medium indicator 135 is correspondingly turned on and off when the medium fan output setting is turned on and off.

The silence fan speed indicator 136 is generally illuminated during a lowest fan output setting. The silence mode of the air cleaner 100 is therefore relatively quiet. The silence fan speed indicator 136 is correspondingly turned on and off when the silence fan output setting is turned on and off.

The turbo fan speed indicator 137 is generally illuminated during turbo mode operation of a fan motor (or motors). The turbo mode is a highest fan output setting. In some embodiments, the turbo mode is automatically controlled by the air cleaner 100, and cannot be activated by a person. The turbo fan speed indicator 137 is correspondingly turned on and off when the turbo fan output setting is turned on and off.

The nightlight indicator 138 is generally illuminated when a nightlight 140 (see below) is activated. The nightlight indicator 138 is correspondingly turned on and off when the nightlight 140 is turned on and off.

The air cleaner 100 further includes a nightlight 140. The nightlight 140 in the embodiment shown is substantially adjacent to the control panel 110. The nightlight 140 in some embodiments is substantially elongate in shape, as shown. However, it should be understood that the nightlight 140 can comprise any shape and size.

The nightlight 140 can perform as a typical nightlight. The nightlight 140 generates light and at least partially illuminates a surrounding area. The nightlight 140 can further illuminate the control panel 110 and enable a person to find the buttons or controls at night.

When the nightlight control 124 is activated, the nightlight 140 is turned on. If the nightlight control 124 comprises a button, the activation can comprise a button press, for example. In addition, the nightlight indicator 138 is illuminated. A subsequent de-activation of the nightlight control 124 turns off the nightlight 140 and the nightlight indicator 138.

FIG. 5 shows the control panel 110 of the air cleaner 100 according to another embodiment of the invention. In this embodiment, the air cleaner 100 does not include a fan turbo feature. As before, the control panel 110 can generate operational changes and/or state changes for the air cleaner 100.

What is claimed is:

1. An air cleaner, comprising:
a volatile memory including an air cleaner state memory element; and
a non-volatile memory including an air cleaner state backup memory element;
wherein the air cleaner is configured to store an air cleaner state to the air cleaner state memory element of the volatile memory and store the air cleaner state to the air cleaner state backup memory element of the non-volatile memory.

2. The air cleaner of claim 1, wherein the air cleaner state is retained in the absence of electrical power.

3. The air cleaner of claim 1, wherein the air cleaner state is stored upon a state change.

4. The air cleaner of claim 1, wherein the air cleaner state is stored upon an operational change.

5. The air cleaner of claim 1, wherein the air cleaner recovers a pre-power cycle air cleaner state.

6. The air cleaner of claim 1, wherein the air cleaner recovers a pre-power loss air cleaner state.

7. The air cleaner of claim 1, with the non-volatile memory comprising a flash memory.

8. The air cleaner of claim 1, further comprising a processing system coupled to the volatile memory and the non-volatile memory, with the processing system being configured to store the air cleaner state to the air cleaner state memory element and store the air cleaner state to the air cleaner state backup memory element.

9. An air cleaner, comprising:
a volatile memory including an air cleaner state memory element;
a non-volatile memory including an air cleaner state backup memory element; and
a processing system coupled to the volatile memory and to the non-volatile memory and configured to store an air cleaner state to the air cleaner state memory element of the volatile memory and store the air cleaner state to the air cleaner state backup memory element of the non-volatile memory.

10. The air cleaner of claim 9, wherein the air cleaner state is retained in the absence of electrical power.

11. The air cleaner of claim 9, wherein the air cleaner state is stored upon a state change.

12. The air cleaner of claim 9, wherein the air cleaner state is stored upon an operational change.

13. The air cleaner of claim 9, wherein the air cleaner recovers a pre-power cycle air cleaner state.

14. The air cleaner of claim 9, wherein the air cleaner recovers a pre-power loss air cleaner state.

15. The air cleaner of claim 9, with the non-volatile memory comprising a flash memory.

16. An air cleaner state backup method, comprising:
storing an air cleaner state to an air cleaner state memory element of a volatile memory; and
storing the air cleaner state to an air cleaner state backup memory element of a non-volatile memory.

17. The method of claim 16, wherein the air cleaner state is retained in the absence of electrical power.

18. The method of claim 16, wherein the air cleaner state is stored upon a state change.

19. The method of claim 16, wherein the air cleaner state is stored upon an operational change.

20. The method of claim 16, wherein the air cleaner recovers a pre-power cycle air cleaner state.

21. The method of claim 16, wherein the air cleaner recovers a pre-power loss air cleaner state.

22. The method of claim 16, with the non-volatile memory comprising a flash memory.
